(19) United States
(12) Patent Application Publication
(10) Pub. No.: US 2023/0245433 A1
(43) Pub. Date: Aug. 3, 2023

(54) Systems and Methods for Implementing a Hybrid Machine Vision Model to Optimize Performance of a Machine Vision Job

(71) Applicant: ZEBRA TECHNOLOGIES CORPORATION, Lincolnshire, IL (US)

(72) Inventor: Duanfeng He, South Setauket, NY (US)

(21) Appl. No.: 17/587,729

(22) Filed: Jan. 28, 2022

(51) Int. Cl. G06V 10/778; G06V 10/774; G06N 20/00; G06F 11/34

(52) U.S. Cl. CPC G06V 10/778; G06V 10/774; G06N 20/00; G06F 11/3409

(57) ABSTRACT

Systems and methods for implementing a hybrid machine vision model to optimize performance of a machine vision job are disclosed herein. An example method includes: (a) receiving, at a machine vision job including one or more machine vision tools, a set of training images; (b) generating, by the machine vision tools, prediction values corresponding to the set of training images; (c) inputting the prediction values into a machine learning (ML) model configured to receive prediction values and output a change value corresponding to the machine vision job; (d) adjusting the machine vision job based on the change value to improve performance of the machine vision job; (e) iteratively performing steps (a)-(e) until the ML model determines that the prediction values satisfy a prediction threshold; and executing, on a machine vision camera, the machine vision job to analyze a run-time image of a target object and output an inspection result.

### BACKGROUND

Over the years, industrial automation has come to rely heavily on machine vision components and systems capable of assisting operators in a wide variety of tasks. In some implementations, machine vision components, like cameras, are utilized to track passing objects, like those which move on conveyor belts past stationary cameras. Often these cameras, along with the backend software, are used to capture images and determine a variety of parameters associated with the passing items. However, training such machine vision systems to accurately and efficiently utilize each component as part of executing a machine vision job can be time intensive and complicated. Conventional machine vision systems relying on machine learning may require minimal human intervention, but are extremely computationally intensive, thereby requiring additional hardware to provide the necessary computing power. Conventional machine vision systems that do not utilize machine learning have a smaller computational load, but are far more difficult to setup and maintain for the responsible field engineer.

Thus, there exists a need for improved systems and methods for implementing a hybrid machine vision model to optimize the performance of a machine vision job.

### SUMMARY

In an embodiment, the present invention is a method for implementing a hybrid machine vision model to optimize performance of a machine vision job. The method may comprise: (a) receiving, at a machine vision job including one or more machine vision tools, a set of training images; (b) generating, by the one or more machine vision tools, prediction values corresponding to the set of training images; (c) inputting the prediction values into a machine learning (ML) model configured to receive prediction values and output a change value corresponding to the machine vision job; (d) adjusting the machine vision job based on the change value to improve performance of the machine vision job; (e) iteratively performing steps (a)-(e) until the ML model determines that the prediction values satisfy a prediction threshold; and executing, on a machine vision camera, the machine vision job to analyze a run-time image of a target object and output an inspection result.

In a variation of this embodiment, each of the one or more machine vision tools includes one or more parameter values, and adjusting the machine vision job based on the change value further comprises: adjusting a first parameter value of the one or more parameter values for a first machine vision tool of the one or more machine vision tools.

In another variation of this embodiment, the one or more machine vision tools includes at least two machine vision tools, and adjusting the machine vision job based on the change value includes adjusting an execution order of the at least two machine vision tools within the machine vision job. Further in this variation, the at least two machine vision tools include at least one of: (i) an edge detection tool, (ii) a pattern matching tool, (iii) a segmentation tool, (iv) a thresholding tool, (v) a barcode decoding tool, (vi) an optical character recognition tool, (vii) an object tracking tool, (viii) an object detection tool, (ix) a color analysis algorithm, or (x) an image filtering tool.

In yet another variation of this embodiment, the ML model uses a cost function to determine whether or not the prediction values satisfy the prediction threshold.

In still another variation of this embodiment, the set of training images includes image labels indicating an inspection result corresponding to each training image, and inputting the prediction values into the ML model further comprises: inputting the prediction values and the image labels into the ML model in order to output the change value.

In yet another variation of this embodiment, the machine vision camera executes the machine vision job to analyze the run-time image without inputting run-time image data into the ML model, and the inspection result corresponds to whether or not the run-time image data satisfies a set of inspection criteria.

In another embodiment, the present invention is a computer system for implementing a hybrid machine vision model to optimize performance of a machine vision job. The computer system comprises: a machine vision camera configured to capture a run-time image of a target object and execute a machine vision job on the run-time image to produce an inspection result, wherein the machine vision job includes one or more machine vision tools; one or more processors; and a non-transitory computer-readable memory coupled to the machine vision camera and the one or more processors. The memory stores instructions thereon that, when executed by the one or more processors, cause the one or more processors to: (a) receive a set of training images, (b) generate, by the one or more machine vision tools, prediction values corresponding to the set of training images, (c) input the prediction values into a machine learning (ML) model configured to receive prediction values and output a change value corresponding to the machine vision job, (d) adjust the machine vision job based on the change value to improve performance of the machine vision job, (e) iteratively perform steps (a)-(e) until the ML model determines that the prediction values satisfy a prediction threshold, and transmit the machine vision job to the machine vision camera for execution on the run-time image.

In a variation of this embodiment, each of the one or more machine vision tools includes one or more parameter values. Moreover, the instructions, when executed by the one or more processors, further cause the one or more processors to: adjust a first parameter value of the one or more parameter values for a first machine vision tool of the one or more machine vision tools.

In another variation of this embodiment, the one or more machine vision tools includes at least two machine vision tools. Moreover, the instructions, when executed by the one or more processors, further cause the one or more processors to: adjust an execution order of the at least two machine vision tools within the machine vision job. Further in this variation, the at least two machine vision tools include at least one of: (i) an edge detection tool, (ii) a pattern matching tool, (iii) a segmentation tool, (iv) a thresholding tool, (v) a barcode decoding tool, (vi) an optical character recognition tool, (vii) an object tracking tool, (viii) an object detection tool, (ix) a color analysis algorithm, or (x) an image filtering tool.

In yet another variation of this embodiment, the ML model uses a cost function to determine whether or not the prediction values satisfy the prediction threshold.

In still another variation of this embodiment, the set of training images includes image labels indicating an inspection result corresponding to each training image. Moreover, the instructions, when executed by the one or more processors, further cause the one or more processors to: input the prediction values and the image labels into the ML model in order to output the change value.

In yet another variation of this embodiment, the machine vision camera executes the machine vision job on the run-time image without inputting run-time image data into the ML model, and the inspection result corresponds to whether or not the run-time image data satisfies a set of inspection criteria.

In yet another embodiment, the present invention is a tangible machine-readable medium comprising instructions for implementing a hybrid machine vision model to optimize performance of a machine vision job. When executed, the instructions cause a machine to at least: (a) receive, at a machine vision job including one or more machine vision tools, a set of training images; (b) generate, by the one or more machine vision tools, prediction values corresponding to the set of training images; (c) input the prediction values into a machine learning (ML) model configured to receive prediction values and output a change value corresponding to the machine vision job; (d) adjust the machine vision job based on the change value to improve performance of the machine vision job; (e) iteratively perform steps (a)-(e) until the ML model determines that the prediction values satisfy a prediction threshold; and transmit the machine vision job to a machine vision camera for execution to analyze a run-time image of a target object and output an inspection result.

In a variation of this embodiment, each of the one or more machine vision tools includes one or more parameter values. Moreover, the instructions, when executed, further cause the machine to at least: adjust a first parameter value of the one or more parameter values for a first machine vision tool of the one or more machine vision tools.

In another variation of this embodiment, the one or more machine vision tools includes at least two machine vision tools. Moreover, the instructions when executed, further cause the machine to at least: adjust an execution order of the at least two machine vision tools within the machine vision job.

In yet another variation of this embodiment, the at least two machine vision tools includes at least one of: (i) an edge detection tool, (ii) a pattern matching tool, (iii) a segmentation tool, (iv) a thresholding tool, (v) a barcode decoding tool, (vi) an optical character recognition tool, (vii) an object tracking tool, (viii) an object detection tool, (ix) a color analysis algorithm, or (x) an image filtering tool.

In still another variation of this embodiment, the set of training images includes image labels indicating an inspection result corresponding to each training image. Moreover, the instructions, when executed, further cause the machine to at least: input the prediction values and the image labels into the ML model in order to output the change value.

In yet another variation of this embodiment, the machine vision camera executes the machine vision job on the run-time image without inputting run-time image data into the ML model, and the inspection result corresponds to whether or not the run-time image data satisfies a set of inspection criteria.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an example system configured for implementing a hybrid machine vision model to optimize performance of a machine vision job, in accordance with embodiments described herein.

FIG. 2A is a perspective view of the imaging device of FIG. 1, in accordance with embodiments described herein.

FIG. 2B is a block diagram of an example logic circuit for implementing example methods and/or operations described herein.

FIG. 3A depicts an example training sequence for the machine vision job of FIG. 1 using change values output from the machine learning model of FIG. 1 based on prediction values corresponding to “good” training images, in accordance with embodiments of the present disclosure.

FIG. 3B depicts an example training sequence for the machine vision job of FIG. 1 using change values output from the machine learning model of FIG. 1 based on prediction values corresponding to “bad” training images, in accordance with embodiments of the present disclosure.

FIG. 4 is a flowchart representative of a method for implementing a hybrid machine vision model to optimize performance of a machine vision job, in accordance with embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Machine vision system owners/operators, particularly in industrial settings, generally have a need to ensure that their machine vision systems operate efficiently and accurately. Machine vision systems may operate with or without machine learning (ML), and both configurations are not ideal. Machine learning typically increases the overall computational resources and time required to operate, and machine vision systems that do not use ML typically require a significant amount of time from a field engineer to setup initially and to maintain the system during operation. Thus, there arises a need to accurately and efficiently operate machine vision systems without the negative impacts associated with using or abstaining from ML in a machine vision system. Approaches described herein address these difficulties and provide a solution which enables such accurate and efficient operation of a machine vision system using ML.

Generally speaking, and as discussed further herein, a machine vision job includes one or more machine vision tools that are each configured to perform a machine vision task, such that the machine vision job collectively performs one or more machine vision tasks when analyzing an image. The techniques described herein provide a hybrid machine vision model to optimize the performance of a machine vision job by utilizing a ML model to train the machine vision job while offline. Specifically, the techniques of the present disclosure input prediction values corresponding to a set of training images generated by the machine vision job into a ML model configured to receive prediction values and output a change value corresponding to the machine vision job. These change values may then be used to adjust the machine vision job to generate more accurate prediction values, thereby improving the performance of the machine vision job. As a result, the techniques of the present disclosure enable accurate and efficient training and operation of a machine vision system to a degree that is unattainable with conventional techniques.

Thus, the techniques of the present disclosure improve over conventional machine vision systems at least by utilizing a ML model to train a machine vision job while offline. Such offline training ensures that the online operation of the machine vision job does not require the cumbersome computational load of conventional ML-based machine vision systems, and avoids the substantial upfront configuration cost and the persistent manual maintenance cost of conventional non-ML-based machine vision systems. Moreover, as a result of the techniques of the present disclosure, machine vision system owners/operators receive consistent, high quality machine vision system output that provides valuable insight corresponding to each owner/operator's manufacturing and/or other processes. Thus, the machine vision system owners/operators may rely on the output of their machine vision system, and can accordingly act to quickly resolve any issues that are accurately identified by the machine vision systems during online operation, thereby increasing manufacturing uptime and overall efficiency.

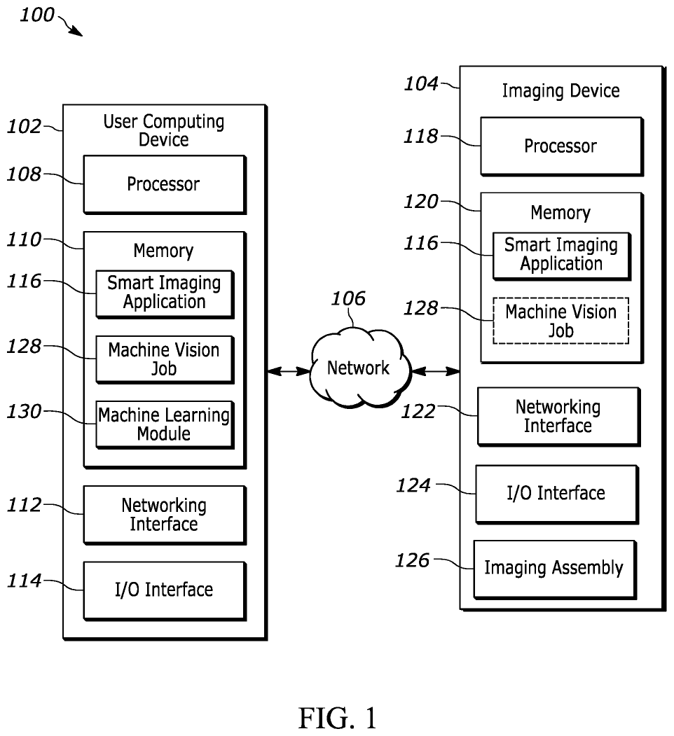

FIG. 1 is an example system 100 configured for implementing a hybrid machine vision model to optimize performance of a machine vision job, in accordance with various embodiments disclosed herein. In the example embodiment of FIG. 1, the imaging system 100 includes a user computing device 102 and an imaging device 104 communicatively coupled to the user computing device 102 via a network 106. Generally speaking, the user computing device 102 and the imaging device 104 may be capable of executing instructions to, for example, implement operations of the example methods described herein, as may be represented by the flowcharts of the drawings that accompany this description. The user computing device 102 is generally configured to enable a user/operator to create a machine vision job for execution on the imaging device 104. When created, the user/operator may then transmit/upload the machine vision job to the imaging device 104 via the network 106, where the machine vision job is then interpreted and executed. The user computing device 102 may comprise one or more operator workstations, and may include one or more processors 108, one or more memories 110, a networking interface 112, an input/output (I/O) interface 114, a smart imaging application 116, a machine vision job 128, and a machine learning (ML) module 130. It is to be understood, that a “machine vision job” as referenced herein may be or include any suitable imaging job including any suitable executable tasks, such as machine vision tasks, anomaly detection/localization tasks, barcode decoding tasks, and/or any other tasks or combinations thereof.

The imaging device 104 is connected to the user computing device 102 via a network 106, and is configured to interpret and execute machine vision jobs (e.g., the machine vision job 128) received from the user computing device 102. Generally, the imaging device 104 may obtain a job file containing one or more job scripts from the user computing device 102 across the network 106 that may define the machine vision job 128 and may configure the imaging device 104 to capture and/or analyze images in accordance with the machine vision job 128. For example, the imaging device 104 may include flash memory used for determining, storing, or otherwise processing imaging data/datasets and/or post-imaging data. The imaging device 104 may then receive, recognize, and/or otherwise interpret a trigger that causes the imaging device 104 to capture an image of a target object in accordance with the configuration established via the one or more job scripts. Once captured and/or analyzed, the imaging device 104 may transmit the images and any associated data across the network 106 to the user computing device 102 for further analysis and/or storage. In various embodiments, the imaging device 104 may be a “smart” camera and/or may otherwise be configured to automatically perform sufficient functionality of the imaging device 104 in order to obtain, interpret, and execute job scripts that define machine vision jobs (e.g., machine vision job 128), such as any one or more job scripts contained in one or more job files as obtained, for example, from the user computing device 102.

Broadly, the job file comprising the machine vision job 128 may be a JSON representation/data format of the one or more job scripts transferrable from the user computing device 102 to the imaging device 104. The job file may further be loadable/readable by a C++ runtime engine, or other suitable runtime engine, executing on the imaging device 104. Moreover, the imaging device 104 may run a server (not shown) configured to listen for and receive job files across the network 106 from the user computing device 102. Additionally, or alternatively, the server configured to listen for and receive job files may be implemented as one or more cloud-based servers, such as a cloud-based computing platform. For example, the server may be any one or more cloud-based platform(s) such as MICROSOFT AZURE, AMAZON AWS, or the like.

The machine vision module 130 may generally train and/or otherwise implement a machine learning model configured to receive prediction values and output a change value corresponding to the machine vision job 128. The machine learning model may be trained with a set of training prediction values generated by the machine vision job 128, and may be trained to output a set of change values corresponding to the set of training prediction values. The machine learning model may output the change value(s) based on any suitable criteria when evaluating the prediction value(s) received from the machine vision job 128. However, in some aspects, the analysis performed by the machine learning model may be broadly characterized as comparing the prediction values generated by the machine vision job 128 to a prediction threshold to determine whether or not the prediction values are sufficiently similar to the known values corresponding to the input images. For example, in certain aspects, the machine learning model uses a cost function to determine whether or not the prediction values satisfy the prediction threshold.

Generally speaking, a change value may represent one or more changes to the machine vision job 128 that may improve the performance of the machine vision job 128. For example, a first change value may cause a first parameter of a first machine vision tool of the machine vision job 128 to be adjusted to a more appropriate value in the context of the specific machine vision task performed by the first machine vision tool for the specific machine vision job 128. A second change value may cause a second parameter of a second machine vision tool of the machine vision job 128 to be adjusted to a more appropriate value in the context of the specific machine vision task performed by the second machine vision tool for the specific machine vision job 128.

Continuing the prior example, a third change value may cause the order of operation of two machine vision tools within the machine vision job 128 to be adjusted to more optimally perform the machine vision tasks of the two machine vision tools. To illustrate, assume that a barcode decoding tool is initially performed first as part of the execution of the machine vision job 128 and an edge detection tool is initially performed second. The third change value output by the machine learning model may reorganize the two tools, such that, during a subsequent execution of the machine vision job 128, the edge detection tool is performed first and the barcode decoding tool is performed second.

In any event, the imaging device 104 may include one or more processors 118, one or more memories 120, a networking interface 122, an I/O interface 124, and an imaging assembly 126. The imaging assembly 126 may include a digital camera and/or digital video camera for capturing or taking digital images and/or frames. Each digital image may comprise pixel data that may be analyzed by one or more tools each configured to perform an image analysis task. The digital camera and/or digital video camera of, e.g., the imaging assembly 126 may be configured, as disclosed herein, to take, capture, or otherwise generate digital images and, at least in some embodiments, may store such images in a memory (e.g., one or more memories 110, 120) of a respective device (e.g., user computing device 102, imaging device 104).

For example, the imaging assembly 126 may include a photo-realistic camera (not shown) for capturing, sensing, or scanning 2D image data. The photo-realistic camera may be an RGB (red, green, blue) based camera for capturing 2D images having RGB-based pixel data. In various embodiments, the imaging assembly may additionally include a three-dimensional (3D) camera (not shown) for capturing, sensing, or scanning 3D image data. The 3D camera may include an Infra-Red (IR) projector and a related IR camera for capturing, sensing, or scanning 3D image data/datasets. In some embodiments, the photo-realistic camera of the imaging assembly 126 may capture 2D images, and related 2D image data, at the same or similar point in time as the 3D camera of the imaging assembly 126 such that the imaging device 104 can have both sets of 3D image data and 2D image data available for a particular surface, object, area, or scene at the same or similar instance in time. In various embodiments, the imaging assembly 126 may include the 3D camera and the photo-realistic camera as a single imaging apparatus configured to capture 3D depth image data simultaneously with 2D image data. Consequently, the captured 2D images and the corresponding 2D image data may be depth-aligned with the 3D images and 3D image data.

In embodiments, the imaging assembly 126 may be configured to capture images of surfaces or areas of a predefined search space or target objects within the predefined search space. For example, each tool included in the machine vision job 128 may additionally include a region of interest (ROI) corresponding to a specific region or a target object imaged by the imaging assembly 126. The composite area defined by the ROIs for all tools included in the machine vision job 128 (or more generally, any machine vision job) may thereby define the predefined search space which the imaging assembly 126 may capture in order to facilitate the execution of the machine vision job 128. However, the predefined search space may be user-specified to include a field of view (FOV) featuring more or less than the composite area defined by the ROIs of all tools included in the particular job script. It should be noted that the imaging assembly 126 may capture 2D and/or 3D image data/datasets of a variety of areas, such that additional areas in addition to the predefined search spaces are contemplated herein. Moreover, in various embodiments, the imaging assembly 126 may be configured to capture other sets of image data in addition to the 2D/3D image data, such as grayscale image data or amplitude image data, each of which may be depth-aligned with the 2D/3D image data.

The imaging device 104 may also process the 2D image data/datasets and/or 3D image datasets for use by other devices (e.g., the user computing device 102, an external server). For example, the one or more processors 118 may process the image data or datasets captured, scanned, or sensed by the imaging assembly 126. The processing of the image data may generate post-imaging data that may include metadata, simplified data, normalized data, result data, status data, or alert data as determined from the original scanned or sensed image data. The image data and/or the post-imaging data may be sent to the user computing device 102 executing the smart imaging application 116 for viewing, manipulation, and/or otherwise interaction. In other embodiments, the image data and/or the post-imaging data may be sent to a server for storage or for further manipulation. As described herein, the user computing device 102, imaging device 104, and/or external server or other centralized processing unit and/or storage may store such data, and may also send the image data and/or the post-imaging data to another application implemented on a user device, such as a mobile device, a tablet, a handheld device, or a desktop device.

Each of the one or more memories 110, 120 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., smart imaging application 116, machine vision job 128, machine learning module 130, and/or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 108, 118 (e.g., working in connection with the respective operating system in the one or more memories 110, 120) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

The one or more memories 110, 120 may store an operating system (OS) (e.g., Microsoft Windows, Linux, Unix, etc.) capable of facilitating the functionalities, apps, methods, or other software as discussed herein. The one or more memories 110 may also store the machine vision job 128, the machine learning module 130, and/or the smart imaging application 116, each of which may be configured to enable the hybrid machine vision model construction/execution, as described further herein. Additionally, or alternatively, the smart imaging application 116 and/or the machine vision job 128 may also be stored in the one or more memories 120 of the imaging device 104, and/or in an external database (not shown), which is accessible or otherwise communicatively coupled to the user computing device 102 via the network 106. The one or more memories 110, 120 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, a machine vision based imaging application, such as the smart imaging application 116, the machine vision job 128, and/or the machine learning module 130 where each may be configured to facilitate their various functionalities discussed herein. It should be appreciated that one or more other applications may be envisioned and that are executed by the one or more processors 108, 118.

The one or more processors 108, 118 may be connected to the one or more memories 110, 120 via a computer bus responsible for transmitting electronic data, data packets, or otherwise electronic signals to and from the one or more processors 108, 118 and one or more memories 110, 120 in order to implement or perform the machine readable instructions, methods, processes, elements or limitations, as illustrated, depicted, or described for the various flowcharts, illustrations, diagrams, figures, and/or other disclosure herein.

The one or more processors 108, 118 may interface with the one or more memories 110, 120 via the computer bus to execute the operating system (OS). The one or more processors 108, 118 may also interface with the one or more memories 110, 120 via the computer bus to create, read, update, delete, or otherwise access or interact with the data stored in the one or more memories 110, 120 and/or external databases (e.g., a relational database, such as Oracle, DB2, MySQL, or a NoSQL based database, such as MongoDB). The data stored in the one or more memories 110, 120 and/or an external database may include all or part of any of the data or information described herein, including, for example, machine vision job 128 images (e.g., images captured by the imaging device 104 in response to execution of the script defining the machine vision job 128) and/or other suitable information.

The networking interfaces 112, 122 may be configured to communicate (e.g., send and receive) data via one or more external/network port(s) to one or more networks or local terminals, such as network 106, described herein. In some embodiments, networking interfaces 112, 122 may include a client-server platform technology such as ASP.NET, Java J2EE, Ruby on Rails, Node.js, a web service or online API, responsive for receiving and responding to electronic requests. The networking interfaces 112, 122 may implement the client-server platform technology that may interact, via the computer bus, with the one or more memories 110, 120 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 112, 122 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 106. In some embodiments, network 106 may comprise a private network or local area network (LAN). Additionally, or alternatively, network 106 may comprise a public network such as the Internet. In some embodiments, the network 106 may comprise routers, wireless switches, or other such wireless connection points communicating to the user computing device 102 (via the networking interface 112) and the imaging device 104 (via networking interface 122) via wireless communications based on any one or more of various wireless standards, including by non-limiting example, IEEE 802.11a/b/c/g (WIFI), the BLUETOOTH standard, or the like. Of course, in certain aspects, the network 106 may be a physical data connection cable that provides a direct connection between the user computing device 102 and the imaging device 104. For example, the network 106 may include a universal serial bus (USB) cable and/or any other suitable physical data connection device or combinations thereof that enable the user computing device 102 and the imaging device 104 to transfer data between the two devices 102, 104.

The I/O interfaces 114, 124 may include or implement operator interfaces configured to present information to an administrator or operator and/or receive inputs from the administrator or operator. An operator interface may provide a display screen (e.g., via the user computing device 102 and/or imaging device 104) which a user/operator may use to visualize any images, graphics, text, data, features, pixels, and/or other suitable visualizations or information. For example, the user computing device 102 and/or imaging device 104 may comprise, implement, have access to, render, or otherwise expose, at least in part, a graphical user interface (GUI) for displaying images, graphics, text, data, features, pixels, and/or other suitable visualizations or information on the display screen. The I/O interfaces 114, 124 may also include I/O components (e.g., ports, capacitive or resistive touch sensitive input panels, keys, buttons, lights, LEDs, any number of keyboards, mice, USB drives, optical drives, screens, touchscreens, etc.), which may be directly/indirectly accessible via or attached to the user computing device 102 and/or the imaging device 104. According to some embodiments, an administrator or user/operator may access the user computing device 102 and/or imaging device 104 to construct jobs, review images or other information, make changes, input responses and/or selections, and/or perform other functions.

As described above herein, in some embodiments, the user computing device 102 may perform the functionalities as discussed herein as part of a “cloud” network or may otherwise communicate with other hardware or software components within the cloud to send, retrieve, or otherwise analyze data or information described herein.

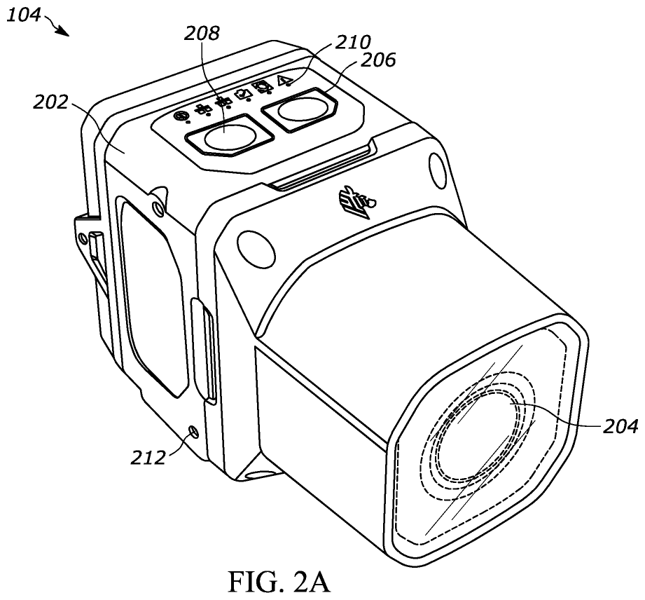

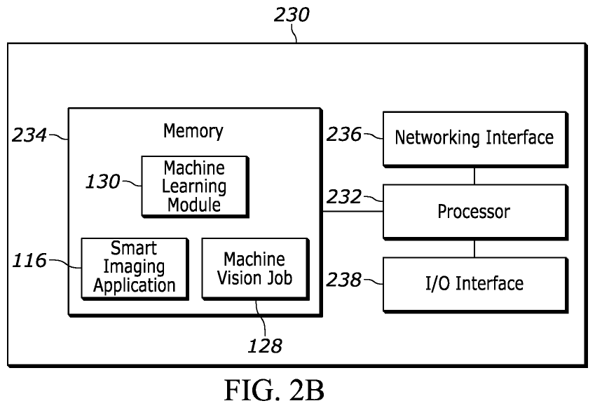

FIG. 2A is a perspective view of the imaging device 104 of FIG. 1, in accordance with embodiments described herein. The imaging device 104 includes a housing 202, an imaging aperture 204, a user interface label 206, a dome switch/button 208, one or more light emitting diodes (LEDs) 210, and mounting point(s) 212. As previously mentioned, the imaging device 104 may obtain job files from a user computing device (e.g., user computing device 102) which the imaging device 104 thereafter interprets and executes. The instructions included in the job file (e.g., job file defining machine vision job 128) may include device configuration settings (also referenced herein as “imaging settings”) operable to adjust the configuration of the imaging device 104 prior to capturing images of a target object.

For example, the device configuration settings may include instructions to adjust one or more settings related to the imaging aperture 204. As an example, assume that at least a portion of the intended analysis corresponding to the machine vision job 128 requires the imaging device 104 to maximize the brightness of any captured image. To accommodate this requirement, the job file of the machine vision job 128 may include device configuration settings to increase the aperture size of the imaging aperture 204. The imaging device 104 may interpret these instructions (e.g., via one or more processors 118) and accordingly increase the aperture size of the imaging aperture 204. Thus, the imaging device 104 may be configured to automatically adjust its own configuration to optimally conform to a particular machine vision job (e.g., machine vision job 128). Additionally, the imaging device 104 may include or otherwise be adaptable to include, for example but without limitation, one or more bandpass filters, one or more polarizers, one or more DPM diffusers, one or more C-mount lenses, and/or one or more C-mount liquid lenses over or otherwise influencing the received illumination through the imaging aperture 204.

The user interface label 206 may include the dome switch/button 208 and one or more LEDs 210, and may thereby enable a variety of interactive and/or indicative features. Generally, the user interface label 206 may enable a user to trigger and/or tune to the imaging device 104 (e.g., via the dome switch/button 208) and to recognize when one or more functions, errors, and/or other actions have been performed or taken place with respect to the imaging device 104 (e.g., via the one or more LEDs 210). For example, the trigger function of a dome switch/button (e.g., dome/switch button 208) may enable a user to capture an image using the imaging device 104 and/or to display a trigger configuration screen of a user application (e.g., smart imaging application 116). The trigger configuration screen may allow the user to configure one or more triggers for the imaging device 104 that may be stored in memory (e.g., one or more memories 110, 120) for use in later developed machine vision jobs, as discussed herein.

As another example, the tuning function of a dome switch/button (e.g., dome/switch button 208) may enable a user to automatically and/or manually adjust the configuration of the imaging device 104 in accordance with a preferred/predetermined configuration and/or to display an imaging configuration screen of a user application (e.g., smart imaging application 116). The imaging configuration screen may allow the user to configure one or more configurations of the imaging device 104 (e.g., aperture size, exposure length, etc.) that may be stored in memory (e.g., one or more memories 110, 120) for use in later developed machine vision jobs, as discussed herein.

To further this example, and as discussed further herein, a user may utilize the imaging configuration screen (or more generally, the smart imaging application 116) to establish two or more configurations of imaging settings for the imaging device 104. The user may then save these two or more configurations of imaging settings as part of a machine vision job (e.g., machine vision job 128) that is then transmitted to the imaging device 104 in a job file containing one or more job scripts. The one or more job scripts may then instruct the imaging device 104 processors (e.g., one or more processors 118) to automatically and sequentially adjust the imaging settings of the imaging device in accordance with one or more of the two or more configurations of imaging settings after each successive image capture.

The mounting point(s) 212 may enable a user connecting and/or removably affixing the imaging device 104 to a mounting device (e.g., imaging tripod, camera mount, etc.), a structural surface (e.g., a warehouse wall, a warehouse ceiling, structural support beam, etc.), other accessory items, and/or any other suitable connecting devices, structures, or surfaces. For example, the imaging device 104 may be optimally placed on a mounting device in a distribution center, manufacturing plant, warehouse, and/or other facility to image and thereby monitor the quality/consistency of products, packages, and/or other items as they pass through the imaging device's 104 FOV. Moreover, the mounting point(s) 212 may enable a user to connect the imaging device 104 to a myriad of accessory items including, but without limitation, one or more external illumination devices, one or more mounting devices/brackets, and the like.

In addition, the imaging device 104 may include several hardware components contained within the housing 202 that enable connectivity to a computer network (e.g., network 106). For example, the imaging device 104 may include a networking interface (e.g., networking interface 122) that enables the imaging device 104 to connect to a network, such as a Gigabit Ethernet connection and/or a Dual Gigabit Ethernet connection. Further, the imaging device 104 may include transceivers and/or other communication components as part of the networking interface to communicate with other devices (e.g., the user computing device 102) via, for example, Ethernet/IP, PROFINET, Modbus TCP, CC-Link, USB 3.0, RS-232, and/or any other suitable communication protocol or combinations thereof.

FIG. 2B is a block diagram representative of an example logic circuit capable of implementing, for example, one or more components of the example user computing device 102 and/or the imaging device 104 of FIG. 1. The example logic circuit of FIG. 2B is a processing platform 230 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 230 of FIG. 2B includes a processor 232 such as, for example, one or more microprocessors, controllers, and/or any suitable type of processor. The example processing platform 230 of FIG. 2B includes memory (e.g., volatile memory, non-volatile memory) 234 accessible by the processor 232 (e.g., via a memory controller). The example processor 232 interacts with the memory 234 to obtain, for example, machine-readable instructions stored in the memory 234 corresponding to, for example, the operations represented by the flowcharts of this disclosure. The memory 234 also includes the smart imaging application 116, the machine vision job 128, and the machine learning module 130 that are each accessible by the example processor 232. The smart imaging application 116, the machine vision job 128, and the machine learning module 130 may comprise rule-based instructions, an artificial intelligence (AI) and/or machine learning-based model, and/or any other suitable algorithm architecture or combination thereof configured to, for example, implement a hybrid machine vision model to optimize the performance of the machine vision job 128, as executed by a machine vision camera (e.g., imaging device 104). To illustrate, the example processor 232 may access the memory 234 to execute the smart imaging application 116, the machine vision job 128, and/or the machine learning module 130 when the imaging device 104 (via the imaging assembly 126) captures an image that includes a target object. Additionally, or alternatively, machine-readable instructions corresponding to the example operations described herein may be stored on one or more removable media (e.g., a compact disc, a digital versatile disc, removable flash memory, etc.) that may be coupled to the processing platform 230 to provide access to the machine-readable instructions stored thereon.

However, it should be appreciated that when the example logic circuit implements one or more components of the imaging device 104 of FIG. 1, then the example processing platform 230 may not include the machine learning module 130. In this manner, the imaging device 104 may operate much faster than conventional machine vision imaging devices that utilize machine learning during runtime operation because the imaging device 104 does not utilize machine learning as part of the runtime operation of the machine vision job 128.

The example processing platform 230 of FIG. 2B also includes a networking interface 236 to enable communication with other machines via, for example, one or more networks. The example networking interface 236 includes any suitable type of communication interface(s) (e.g., wired and/or wireless interfaces) configured to operate in accordance with any suitable protocol(s) (e.g., Ethernet for wired communications and/or IEEE 802.11 for wireless communications).

The example processing platform 230 of FIG. 2B also includes input/output (I/O) interfaces 238 to enable receipt of user input and communication of output data to the user. Such user input and communication may include, for example, any number of keyboards, mice, USB drives, optical drives, screens, touchscreens, etc.

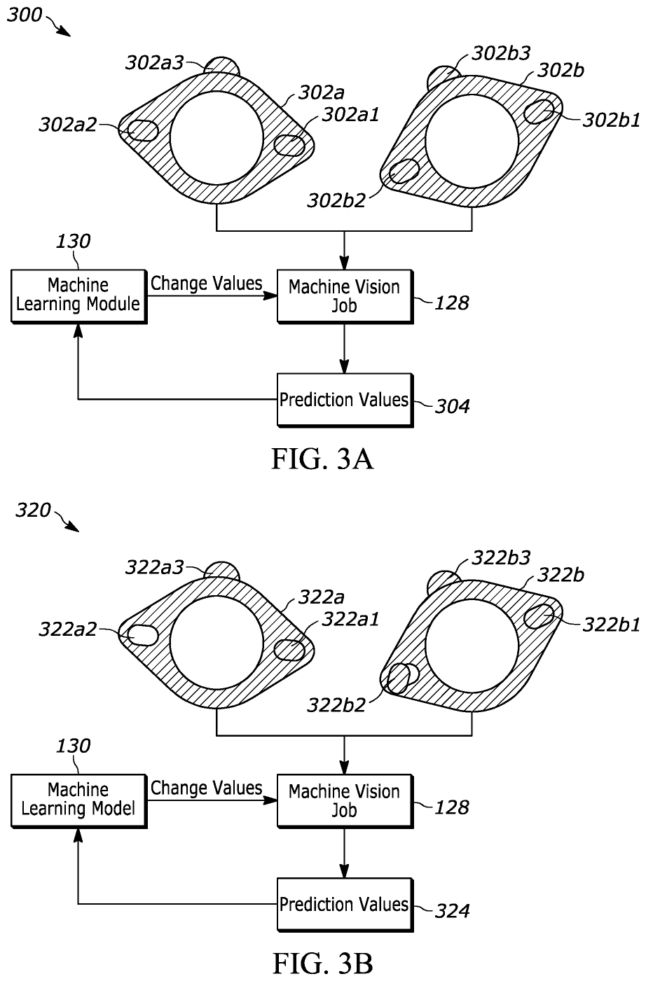

FIG. 3A depicts an example training sequence 300 for the machine vision job 128 of FIG. 1 using change values output from the machine learning model trained by the machine learning module 130 of FIG. 1 based on prediction values corresponding to “good” training images, in accordance with embodiments of the present disclosure. As referenced herein, a “good” training image generally corresponds to a training image that features a target object that does not contain any visual defects and/or would otherwise pass a visual inspection from a properly configured machine vision job executed by a machine vision system. Accordingly, a “bad” training image generally corresponds to a training image that features a target object that does contain a visual defect and/or would otherwise fail a visual inspection from a properly configured machine vision job executed by a machine vision system.

The example training sequence 300 includes a first good training image 302a and a second good training image 302b that each feature a target object at a particular stage in a manufacturing/fabrication process. Generally, an imaging device (e.g., imaging device 104) may capture the first good training image 302a and the second good training image 302b, and a user computing device (e.g., user computing device 102) may receive the good training images 302a, 302b from the imaging device 104 in order to perform the actions of the example training sequence 300. Of course, in certain embodiments, the imaging device 104 may capture the good training images 302a, 302b and thereafter perform the actions of the example training sequence 300.

In any event, these training images 302a, 302b may qualify as “good” training images because, for example, the side tabs 302a1, 302a2, 302b1, 302b2 are located within the appropriate side areas of the target objects without any visible defects, and the top tabs 302a3, 302b3 are also located at the appropriate top areas of the target objects without any visible defects. The processors (e.g., one or more processors 108, 118) executing the machine vision job 128 may receive the good training images 302a, 302b, and may execute the machine vision job 128 on the good training images 302a, 302b to thereby generate prediction values 304 corresponding to both good training images 302a, 302b. The prediction values 304 may generally correspond to whether or not the machine vision job 128 classifies each of the good training images 302a, 302b as either “good” or “bad”.

For example, the processors executing the machine vision job 128 may output a prediction value 304 corresponding to the first good training image 302a indicating that the first good training image 302a is “good”, and the processors executing the machine vision job 128 may output a prediction value 304 corresponding to the second good training image 302b indicating that the second good training image 302b is “bad”. While the machine vision job 128 has returned a correct result for the first good training image 302a (e.g., “good”), the job 128 has returned an incorrect result for the second good training image 302b (e.g., “bad”). Accordingly, the machine learning module 130 may receive the prediction values 304 in order to adjust the machine vision job 128 in a manner that eliminates the potential for similar incorrect/erroneous results to occur during online execution of the machine vision job 128.

Namely, the machine learning module 130 receives the prediction values 304 from the machine vision job 128 (e.g., the processors 108, 118 executing the machine vision job 128) in order to evaluate whether or not change values should be output to adjust/change the configuration of the machine vision job 128. As previously mentioned, the change values may generally represent one or more changes to the machine vision job 128 that may improve the performance of the machine vision job 128. In particular, the change values may include adjustments to parameters of the individual machine vision tools comprising the machine vision job 128, adjustments to the order of execution of the individual machine vision tools comprising the machine vision job 128, and/or any other suitable adjustments to the machine vision job 128 or combinations thereof.

Continuing the above example, the machine learning module 130 may receive the prediction values 304, and may generate change values based on analyzing that the prediction value 304 corresponding to the first good training image 302a is correct (e.g., “good”) and that the prediction value 304 corresponding to the second good training image 302b is incorrect (e.g., “bad”). In certain aspects, a user/operator may examine each of the good training images 302a, 302b prior to the example training sequence 300 in order to determine image labels for each image 302a, 302b that indicate a correct inspection result for the images 302a, 302b (e.g., “good” for both images 302a, 302b). These image labels may be provided to the machine learning module 130, which may then apply the machine learning model to some and/or all of the prediction values 304, the image labels corresponding to each good training image 302a, 302b, and/or the good training images 302a, 302b.

As an example, the machine vision job 128 may utilize an edge detection tool in an attempt to identify the side tabs 302a1, 302a2, 302b1, 302b2, and the edge detection tool may have a region of interest (ROI) placed at approximately the location of the side tabs 302a1, 302a2 indicating where the side tabs are typically located within captured images. The edge detection tool may fail to locate the side tabs 302b1, 302b2 because the target object in the second good training image 302b is rotated relative to the target object in the first good training image 302a, placing the side tabs 302b1, 302b2 outside of the edge detection tool ROI. Accordingly, the edge detection tool may determine that the first good training image 302a is “good”, in part, because each of the side tabs 302a1, 302a2 are located within the ROI, and that the second good training image 302b is “bad”, in part, because each of the side tabs 302b1, 302b2 are located outside of the ROI and are therefore undetected. In this example, the machine vision job 128 may include the results of the edge detection tool as part of the prediction values 304 indicating why the good training images 302a, 302b were categorized as “good” and “bad”, respectively, such that the machine learning module 130 receives information indicating the outcome of the machine vision job 128 (e.g., “good”, “bad”), as well as individual tool inspection results. The machine learning module 130 may then apply the machine learning model to the prediction values 304 to determine change values corresponding to, for example, the ROI of the edge detection tool in order to increase the frequency/consistency of correct analysis for each training image (e.g., 302a, 302b) by the machine vision job 128 on subsequent iterations.

As another example, the machine vision job 128 may utilize a pattern match tool in order to locate the top tabs 302a3 and 302b3. Based on the identified locations of the top tabs 302a3 and 302b3, the machine vision job 128 may utilize fixtured ROIs for each of the side tabs 302a2, 302b2, 302a1, 302b1. The fixtured ROIs may indicate that the expected locations of the side tabs correspond to the actual locations of the side tabs 302a1, 302a2, 302b1, 302b2, such that the pattern match tool may also identify the side tabs 302a1, 302a2, 302b1, 302b2 within the captured training images 302a, 302b, and thereby determine that both of the training images 302a, 302b are “good”. Alternatively, the machine vision job 128 may apply a pattern match tool on the entirety of the good training images 302a, 302b, and may individually identify the side tabs 302a1, 302a2, 302b1, 302b2 and the top tabs 302a3, 302b3 to determine that the good training images 302a, 302b are “good”.

As yet another example, the machine vision job 128 may utilize an edge detection tool in an attempt to identify the top tabs 302a3, 302b3, and the edge detection tool may have a region of interest (ROI) placed at approximately the location of the top tab 302a3 indicating where the top tab is typically located within captured images. The edge detection tool may fail to locate the top tab 302b3 because the target object in the second good training image 302b is rotated relative to the target object in the first good training image 302a, placing the top tab 302b3 outside of the edge detection tool ROI. Accordingly, the edge detection tool may determine that the first good training image 302a is “good”, in part, because the top tab 302a3 is located within the ROI, and that the second good training image 302b is “bad”, in part, because the top tab 302b3 is located outside of the ROI and is therefore undetected. In this example, the machine vision job 128 may include the results of the edge detection tool as part of the prediction values 304 indicating why the good training images 302a, 302b were categorized as “good” and “bad”, respectively, such that the machine learning module 130 receives information indicating the outcome of the machine vision job 128 (e.g., “good”, “bad”), as well as individual tool inspection results. The machine learning module 130 may then apply the machine learning model to the prediction values 304 to determine change values corresponding to, for example, the ROI of the edge detection tool in order to increase the frequency/consistency of correct analysis for each training image (e.g., 302a, 302b) by the machine vision job 128 on subsequent iterations.

Thus, in general, the ML module 130 may train the ML model to figure out which machine vision tool to use, and in what order to apply the machine vision tools. When more than one machine vision tool can be used to achieve the same result, the ML model may utilize execution time and margin of safety as parameters to determine an optimal/preferred ordering and execution parameters for each of the machine vision tools. In a certain aspect, the ML model may include a cost function in order to analyze the execution time and margin of safety when determining the optimal/preferred ordering and execution parameters for each machine vision tool included as part of the machine vision job 128.

As a result of this iterative adjustment provided by the change values of the machine learning model applied by the machine learning module 130, the performance of the machine vision job 128 may iteratively improve until the machine vision job 128 consistently provides accurate analysis with regard to training images during the offline training of the machine vision job 128. However, in order to provide these iterative adjustments, and as previously mentioned, the machine learning module 130 may first train the machine learning model to output the change values corresponding to the prediction values of the machine vision job 128.

Broadly speaking, the machine learning model that is included as part of the machine learning module 130 may be trained with a plurality of prediction values that each correspond to a training image of a plurality of training images (e.g., good training images 302a, 302b), a plurality of image labels that each correspond to one training image of the plurality of training images, and a plurality of ground truth change values corresponding to change values that would be output from a properly trained machine learning model applied by the machine learning module 130. In this manner, the machine learning module 130 may accurately and efficiently generate change values that identify deficiencies in the configuration of the machine vision job 128 because the machine learning model is trained using the plurality of prediction values and plurality of image labels. As referenced herein, a “deficiency” in the configuration of the machine vision job 128 generally indicates a parameter, execution order, and/or other setting of the machine vision job 128 that results in the machine vision job 128 outputting inaccurate prediction values (e.g., prediction values 304) in response to receiving and analyzing input images (e.g., good training images 302a, 302b).

Generally, machine learning may involve identifying and recognizing patterns in existing data (such as generating change values identifying configuration deficiencies within the machine vision job 128) in order to facilitate making predictions or identification for subsequent data (such as using the model on a new prediction value in order to determine or generate a change value identifying one or more configuration deficiencies of the machine vision job 128). Machine learning model(s), such as the AI based learning models (e.g., included as part of the machine learning module 130) described herein for some aspects, may be created and trained based upon example data (e.g., “training data”) inputs or data (which may be termed “features” and “labels”) in order to make valid and reliable predictions for new inputs, such as testing level or production level data or inputs.

More specifically, the machine learning model that is included as part of the machine learning module 130 may be trained using one or more supervised machine learning techniques. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based on the discovered rules, relationships, or model, an expected output.

For example, in certain aspects, the supervised machine learning model may employ a neural network, which may be a convolutional neural network (CNN), a deep learning neural network, or a combined learning module or program that learns in two or more features or feature datasets (e.g., prediction values) in particular areas of interest. The machine learning programs or algorithms may also include natural language processing, semantic analysis, automatic reasoning, support vector machine (SVM) analysis, decision tree analysis, random forest analysis, K-Nearest neighbor analysis, naïve Bayes analysis, clustering, reinforcement learning, and/or other machine learning algorithms and/or techniques. In some aspects, the artificial intelligence and/or machine learning based algorithms may be included as a library or package executed on the server(s) 102. For example, libraries may include the TENSORFLOW based library, the PYTORCH library, and/or the SCIKIT-LEARN Python library.

The supervised machine learning model may be configured to receive an input prediction value (e.g., prediction value 304) and output a change value as a result of the training performed using the plurality of training prediction values, plurality of image labels, and the corresponding ground truth change values. The output of the supervised machine learning model during the training process may be compared with the corresponding ground truth change values. In this manner, the machine learning module 130 may accurately and consistently generate change values that identify configuration deficiencies of the machine vision job 128 because the differences between the change values and the corresponding ground truth change values may be used to modify/adjust and/or otherwise inform the weights/values of the supervised machine learning model (e.g., an error/cost function).

As previously mentioned, machine learning may generally involve identifying and recognizing patterns in existing data (such as generating training change values identifying configuration deficiencies within the machine vision job 128 based on training prediction values) in order to facilitate making predictions or identification for subsequent data (such as using the model on a new prediction value indicative of a configuration deficiency of the machine vision job 128 in order to determine or generate a change value identifying the configuration deficiency within the new prediction value).

Additionally, or alternatively, in certain aspects, the machine learning model included as part of the machine learning module 130, may be trained using one or more unsupervised machine learning techniques. In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated.

It should be understood that the unsupervised machine learning model included as part of the machine learning module 130 may be comprised of any suitable unsupervised machine learning model, such as a neural network, which may be a deep belief network, Hebbian learning, or the like, as well as method of moments, principal component analysis, independent component analysis, isolation forest, any suitable clustering model, and/or any suitable combination thereof.

It should be understood that, while described herein as being trained using a supervised/unsupervised learning technique, in certain aspects, the AI based learning models described herein may be trained using multiple supervised/unsupervised machine learning techniques. Moreover, it should be appreciated that the change value generations may be performed by a supervised/unsupervised machine learning model and/or any other suitable type of machine learning model or combinations thereof.

Regardless, training the AI based learning models (e.g., included as part of the machine learning module 130) described herein may also comprise retraining, relearning, or otherwise updating models with new, or different, information, which may include information received, ingested, generated, or otherwise used over time. Moreover, in various aspects, the AI based learning models (e.g., included as part of the machine learning module 130) may be trained, by one or more processors (e.g., one or more processor(s) 108 of user computing device 102 and/or processors 118 of the imaging device 104) with the plurality of prediction values, corresponding plurality of image labels, and the plurality of ground truth change values.

FIG. 3B depicts an example training sequence 320 for the machine vision job 128 of FIG. 1 using change values output from the machine learning model trained by the machine learning module 130 of FIG. 1 based on prediction values corresponding to “bad” training images, in accordance with embodiments of the present disclosure. As previously mentioned, a “bad” training image generally corresponds to a training image that features a target object that contains a visual defect and/or would otherwise fail a visual inspection from a properly configured machine vision job executed by a machine vision system.

The example training sequence 320 includes a first bad training image 322a and a second bad training image 322b that each feature a target object at a particular stage in a manufacturing/fabrication process. Generally, an imaging device (e.g., imaging device 104) may capture the first bad training image 322a and the second bad training image 322b, and a user computing device (e.g., user computing device 102) may receive the bad training images 322a, 322b from the imaging device 104 in order to perform the actions of the example training sequence 320. Of course, in certain embodiments, the imaging device 104 may capture the bad training images 322a, 322b and thereafter perform the actions of the example training sequence 320.

In any event, these training images 322a, 322b may qualify as “bad” training images because, for example, the side tabs 322a2, and 322b2 are not located within the appropriate side areas of the target objects. Instead, the side tab 322b2 is erroneously placed within the respective side area of the target object featured in the second bad training image 322b, and the side tab 322a2 is completely missing from the target object featured in the first bad training image 322a. The processors (e.g., one or more processors 108, 118) executing the machine vision job 128 may receive the bad training images 322a, 322b, and may execute the machine vision job 128 on the bad training images 322a, 322b to thereby generate prediction values 324 corresponding to both bad training images 322a, 322b. The prediction values 324 may generally correspond to whether or not the machine vision job 128 classifies each of the bad training images 322a, 322b as either “good” or “bad”.

For example, the processors executing the machine vision job 128 may output a prediction value 324 corresponding to the first bad training image 322a indicating that the first bad training image 322a is “bad”, and the processors executing the machine vision job 128 may output a prediction value 324 corresponding to the second bad training image 322b indicating that the second good training image 322b is “good”. While the machine vision job 128 has returned a correct result for the first good training image 322a (e.g., “bad”), the job 128 has returned an incorrect result for the second good training image 322b (e.g., “good”). Accordingly, the machine learning module 130 may receive the prediction values 324 in order to adjust the machine vision job 128 in a manner that eliminates the potential for similar incorrect/erroneous results to occur during online execution of the machine vision job 128.

Namely, the machine learning module 130 receives the prediction values 324 from the machine vision job 128 (e.g., the processors 108, 118 executing the machine vision job 128) in order to evaluate whether or not change values should be output to adjust/change the configuration of the machine vision job 128. As previously mentioned, the change values may generally represent one or more changes to the machine vision job 128 that may improve the performance of the machine vision job 128. In particular, the change values may include adjustments to parameters of the individual machine vision tools comprising the machine vision job 128, adjustments to the order of execution of the individual machine vision tools comprising the machine vision job 128, and/or any other suitable adjustments to the machine vision job 128 or combinations thereof.

Continuing the above example, the machine learning module 130 may receive the prediction values 324, and may generate change values based on analyzing that the prediction value 324 corresponding to the first bad training image 322a is correct (e.g., “bad”) and that the prediction value 324 corresponding to the second bad training image 322b is incorrect (e.g., “good”). In certain aspects, a user/operator may examine each of the bad training images 322a, 322b prior to the example training sequence 320 in order to determine image labels for each image 322a, 322b that indicate a correct inspection result for the images 322a, 322b (e.g., “bad” for both images 322a, 322b). These image labels may be provided to the machine learning module 130, which may then apply the machine learning model to some and/or all of the prediction values 324, the image labels corresponding to each bad training image 322a, 322b, and/or the bad training images 322a, 322b.

As an example, the machine vision job 128 may utilize an edge detection tool in an attempt to identify the side tabs 322a1, 322a2, 322b1, 322b2, and the edge detection tool may have a region of interest (ROI) placed at approximately the location of the side tabs 322a1/322b1 and 322a2/322b2 indicating where the side tabs are typically located within captured images. More specifically, the edge detection tool may have an ROI that includes both sets of side tabs 322a1/322b1 and 322a2/322b2 based on change values used to modify the configuration of the machine vision job 128 as a result of the example training sequence 300. The edge detection tool may fail to locate the side tab 322a2 because the side tab 322a2 in the first bad training image 322a is missing entirely from the target object in the first bad training image 322a, despite the side tab 322a2 being within the edge detection tool ROI. Accordingly, the edge detection tool may determine that the first bad training image 322a is “bad”, in part, because the side tab 322a2 is not located within the ROI.

However, continuing this example, despite beneficially changing the ROI of the edge detection tool as a result of the example training sequence 300, the tool may still not be optimally configured for the machine vision job 128. Namely, the ROI of the edge detection tool may extend to include the side tab 322b2, but the tool may fail to recognize that the tab 322b2 is erroneously placed relative to the proper location for the tab 322b2. Accordingly, the edge detection tool may determine that the second bad training image 322b is “good”, in part, because each of the side tabs 322b1, 322b2 are located within the ROI and are erroneously determined to be properly located within the target object of the second bad training image 322b.

In this example, the machine vision job 128 may include the results of the edge detection tool as part of the prediction values 324 indicating why the bad training images 322a, 322b were categorized as “bad” and “good”, respectively, such that the machine learning module 130 receives information indicating the outcome of the machine vision job 128 (e.g., “good”, “bad”), as well as individual tool inspection results. The machine learning module 130 may then apply the machine learning model to the prediction values 324 to determine change values corresponding to, for example, the ROI of the edge detection tool in order to increase the frequency/consistency of correct analysis for each training image (e.g., 322a, 322b) by the machine vision job 128 on subsequent iterations.

As another example, the machine vision job 128 may utilize an edge detection tool in an attempt to identify the top tabs 322a3, 322b3, and the edge detection tool may have a region of interest (ROI) placed at approximately the location of the top tabs 322a3, 322b3 indicating where the top tab is typically located within captured images. The edge detection tool may properly locate both top tabs 322a3, 322b3 because the target objects in the bad training images 322a, 322b are oriented such that the top tabs 322a3, 322b3 are located within the edge detection tool ROI. Accordingly, the edge detection tool may determine that the both bad training images 322a, 322b are “good” insofar as the top tabs 322a3, 322b3 are located within the ROI and properly located with respect to the target objects featured in the bar training images 322a, 322b. In this example, the machine vision job 128 may include the results of the edge detection tool as part of the prediction values 324 indicating why the bad training images 322a, 322b would otherwise be categorized as “good”, apart from the erroneous locations of the respective side tabs 322a2, 322b2, such that the machine learning module 130 receives information indicating the outcome of the machine vision job 128 (e.g., “good”, “bad”), as well as individual tool inspection results. The machine learning module 130 may then apply the machine learning model to the prediction values 324 to determine change values corresponding to, for example, the ROI of the edge detection tool in order to increase the frequency/consistency of correct analysis for each training image (e.g., 322a, 322b) by the machine vision job 128 on subsequent iterations.

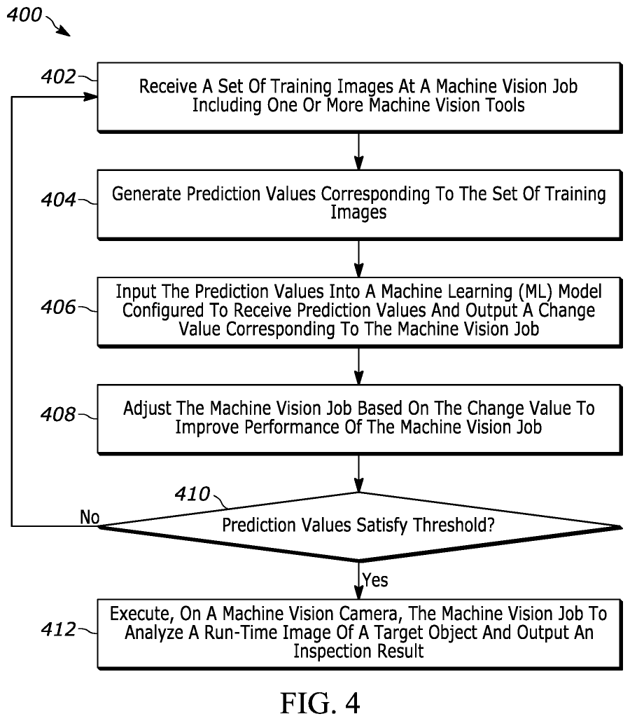

FIG. 4 is a flowchart representative of a method 400 for implementing a hybrid machine vision model to optimize performance of a machine vision job, in accordance with embodiments described herein. Each block described herein may be optional in certain embodiments. Further, while the actions included as part of the method 400 are described herein as being executed and/or otherwise performed by one or more processors 108, it is to be understood that each of the actions included as part of the method 400 may be performed by any suitable processor (e.g., processors 118).

The method 400 includes receiving, at a machine vision job (e.g., machine vision job 128) including one or more machine vision tools, a set of training images (e.g., training images 302a, 302b, 322a, 322b) (block 402). The method 400 may further include generating, by the one or more machine vision tools, prediction values (e.g., prediction values 304, 324) corresponding to the set of training images (block 404). The method may further include inputting the prediction values into a machine learning (ML) model (e.g., applied by the machine learning module 130) that is configured to receive prediction values and output a change value corresponding to the machine vision job.

In certain aspects, the ML model uses a cost function to determine whether or not the prediction values satisfy the prediction threshold. In some aspects, the set of training images includes image labels indicating an inspection result corresponding to each training image. For example, as previously described, a user/operator may provide the image labels corresponding to each training image, in order for the machine learning model to determine whether or not the prediction values corresponding to the training images match the image labels for the training images. As such the ML model may receive the prediction values and image labels as input in order to output the change value(s) configured to change some aspect of the machine vision job.

In particular, the method 400 may further include adjusting the machine vision job based on the change value to improve performance of the machine vision job (block 408). As an example, each of the one or more machine vision tools included in the machine vision job may include one or more parameter values, and the change value may be configured to adjust a first parameter value of the one or more parameter values for a first machine vision tool of the one or more machine vision tools. In this manner, the change values may alter the execution of the machine vision job, such that the machine vision job may more optimally perform the required tasks associated with the machine vision tools.

As another example, the one or more machine vision tools may include at least two machine vision tools, and adjusting the machine vision job based on the change value may include adjusting an execution order of the at least two machine vision tools within the machine vision job. Namely, the machine vision job may include an edge detection tool and a pattern matching tool, and prior to the application of the change value to the machine vision job, the pattern matching tool may be executed before the edge detection tool. The change value generated by the machine learning model may change the execution order of the machine vision tools, such that after application of the change value to the machine vision job, the edge detection tool is executed before the pattern matching tool. Further in these aspects, the at least two machine vision tools may include at least one of: (i) an edge detection tool, (ii) a pattern matching tool, (iii) a segmentation tool, (iv) a thresholding tool, (v) a barcode decoding tool, (vi) an optical character recognition tool, (vii) an object tracking tool, (viii) an object detection tool, (ix) a color analysis algorithm, or (x) an image filtering tool. Of course, it will be appreciated that any suitable machine vision tool may be included as part of the machine vision job.

The method 400 may further include determining whether or not the prediction values satisfy a prediction threshold (block 410). The prediction threshold may correspond to a percentage, ratio, and/or any other suitable value indicating, for example, an amount of correct prediction values when compared to the image labels, and/or any other suitable metric or combinations thereof. If the ML model determines that the prediction values do not satisfy the prediction threshold (NO branch of block 410), then the method 400 may return to block 402.

However, if the ML model determines that the prediction values satisfy the prediction threshold (YES branch of block 410), then the method 400 may proceed to block 412. In particular, the method 400 may further include executing, on a machine vision camera, the machine vision job to analyze a run-time image of a target object and output an inspection result (block 412). Generally, the inspection results may correspond to “good”, “bad”, and/or other designations indicating whether or not the run-time images “pass” or “fail” the run-time inspection performed by the machine vision job.

Moreover, once the ML model determines that the prediction values satisfy the prediction threshold, the machine vision camera configured to execute the machine vision job may thereafter utilize the machine vision job during run-time execution of the machine vision camera. In certain aspects, the machine vision camera executes the machine vision job to analyze the run-time image without inputting run-time image data into the ML model. Further in these aspects, the inspection result may correspond to whether or not the run-time image data satisfies a set of inspection criteria. The set of inspection criteria may correspond to the analysis performed by the various machine vision tools included as part of the machine vision job. For example, a first inspection criteria may be the location of the side tabs (e.g., 302a1, 302a2, 302b1, 302b2, 322a1, 322a2, 322b1, 322b2) on the target object in the run-time images. A second inspection criteria may be the location of the top tab (e.g., 302a3, 302b3, 322a3, 322b3) on the target object in the run-time images. Of course, the set of inspection criteria may include any suitable criteria that may be analyzed as part of a machine vision job.

Additional Considerations

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for implementing a hybrid machine vision model to optimize performance of a machine vision job, the method comprising:
(a) receiving, at a machine vision job including one or more machine vision tools, a set of training images;
(b) generating, by the one or more machine vision tools, prediction values corresponding to the set of training images;
(c) inputting the prediction values into a machine learning (ML) model configured to receive prediction values and output a change value corresponding to the machine vision job;
(d) adjusting the machine vision job based on the change value to improve performance of the machine vision job;
(e) iteratively performing steps (a)-(e) until the ML model determines that the prediction values satisfy a prediction threshold; and
executing, on a machine vision camera, the machine vision job to analyze a run-time image of a target object and output an inspection result.

2. The method of claim 1, wherein each of the one or more machine vision tools includes one or more parameter values, and adjusting the machine vision job based on the change value further comprises:
adjusting a first parameter value of the one or more parameter values for a first machine vision tool of the one or more machine vision tools.

3. The method of claim 1, wherein the one or more machine vision tools includes at least two machine vision tools, and adjusting the machine vision job based on the change value includes adjusting an execution order of the at least two machine vision tools within the machine vision job.

4. The method of claim 3, wherein the at least two machine vision tools include at least one of: (i) an edge detection tool, (ii) a pattern matching tool, (iii) a segmentation tool, (iv) a thresholding tool, (v) a barcode decoding tool, (vi) an optical character recognition tool, (vii) an object tracking tool, (viii) an object detection tool, (ix) a color analysis algorithm, or (x) an image filtering tool.

5. The method of claim 1, wherein the ML model uses a cost function to determine whether or not the prediction values satisfy the prediction threshold.

6. The method of claim 1, wherein the set of training images includes image labels indicating an inspection result corresponding to each training image, and inputting the prediction values into the ML model further comprises:
inputting the prediction values and the image labels into the ML model in order to output the change value.

7. The method of claim 1, wherein the machine vision camera executes the machine vision job to analyze the run-time image without inputting run-time image data into the ML model, and the inspection result corresponds to whether or not the run-time image data satisfies a set of inspection criteria.

8. A computer system for implementing a hybrid machine vision model to optimize performance of a machine vision job, the system comprising:
a machine vision camera configured to capture a run-time image of a target object and execute a machine vision job on the run-time image to produce an inspection result, wherein the machine vision job includes one or more machine vision tools;
one or more processors; and
a non-transitory computer-readable memory coupled to the machine vision camera and the one or more processors, the memory storing instructions thereon that, when executed by the one or more processors, cause the one or more processors to:
(a) receive a set of training images,
(b) generate, by the one or more machine vision tools, prediction values corresponding to the set of training images,
(c) input the prediction values into a machine learning (ML) model configured to receive prediction values and output a change value corresponding to the machine vision job,
(d) adjust the machine vision job based on the change value to improve performance of the machine vision job,
(e) iteratively perform steps (a)-(e) until the ML model determines that the prediction values satisfy a prediction threshold, and
transmit the machine vision job to the machine vision camera for execution on the run-time image.

9. The computer system of claim 8, wherein each of the one or more machine vision tools includes one or more parameter values, and the instructions, when executed by the one or more processors, further cause the one or more processors to:
adjust a first parameter value of the one or more parameter values for a first machine vision tool of the one or more machine vision tools.

10. The computer system of claim 8, wherein the one or more machine vision tools includes at least two machine vision tools, and the instructions, when executed by the one or more processors, further cause the one or more processors to:
adjust an execution order of the at least two machine vision tools within the machine vision job.

11. The computer system of claim 10, wherein the at least two machine vision tools include at least one of: (i) an edge detection tool, (ii) a pattern matching tool, (iii) a segmentation tool, (iv) a thresholding tool, (v) a barcode decoding tool, (vi) an optical character recognition tool, (vii) an object tracking tool, (viii) an object detection tool, (ix) a color analysis algorithm, or (x) an image filtering tool.

12. The computer system of claim 8, wherein the ML model uses a cost function to determine whether or not the prediction values satisfy the prediction threshold.

13. The computer system of claim 8, wherein the set of training images includes image labels indicating an inspection result corresponding to each training image, and the instructions, when executed by the one or more processors, further cause the one or more processors to:
input the prediction values and the image labels into the ML model in order to output the change value.

14. The computer system of claim 8, wherein the machine vision camera executes the machine vision job on the run-time image without inputting run-time image data into the ML model, and the inspection result corresponds to whether or not the run-time image data satisfies a set of inspection criteria.

15. A tangible machine-readable medium comprising instructions for implementing a hybrid machine vision model to optimize performance of a machine vision job, when executed, cause a machine to at least:
(a) receive, at a machine vision job including one or more machine vision tools, a set of training images;
(b) generate, by the one or more machine vision tools, prediction values corresponding to the set of training images;
(c) input the prediction values into a machine learning (ML) model configured to receive prediction values and output a change value corresponding to the machine vision job;
(d) adjust the machine vision job based on the change value to improve performance of the machine vision job;
(e) iteratively perform steps (a)-(e) until the ML model determines that the prediction values satisfy a prediction threshold; and
transmit the machine vision job to a machine vision camera for execution to analyze a run-time image of a target object and output an inspection result.

16. The tangible machine-readable medium of claim 15, wherein each of the one or more machine vision tools includes one or more parameter values, and the instructions, when executed, further cause the machine to at least:
adjust a first parameter value of the one or more parameter values for a first machine vision tool of the one or more machine vision tools.

17. The tangible machine-readable medium of claim 15, wherein the one or more machine vision tools includes at least two machine vision tools, and the instructions, when executed, further cause the machine to at least:
adjust an execution order of the at least two machine vision tools within the machine vision job.

18. The tangible machine-readable medium of claim 15, wherein the at least two machine vision tools include at least one of: (i) an edge detection tool, (ii) a pattern matching tool, (iii) a segmentation tool, (iv) a thresholding tool, (v) a barcode decoding tool, (vi) an optical character recognition tool, (vii) an object tracking tool, (viii) an object detection tool, (ix) a color analysis algorithm, or (x) an image filtering tool.

19. The tangible machine-readable medium of claim 15, wherein the set of training images includes image labels indicating an inspection result corresponding to each training image, and the instructions, when executed, further cause the machine to at least:
input the prediction values and the image labels into the ML model in order to output the change value.

20. The tangible machine-readable medium of claim 15, wherein the machine vision camera executes the machine vision job on the run-time image without inputting run-time image data into the ML model, and the inspection result corresponds to whether or not the run-time image data satisfies a set of inspection criteria.
